(19) United States
(12) Patent Application Publication
(10) Pub. No.: US 2026/0106060 A1
(43) Pub. Date: Apr. 16, 2026

(54) NdFeB MAGNET AND PREPARATION METHOD

(71) Applicants: TIANJIN SANHUAN LUCKY NEW MATERIAL CO.,LTD., Tianjin (CN); BEIJING ZHONG KE SAN HUAN HI-TECH CO., LTD., Beijing (CN)

(72) Inventors: Lijun CAO, Tianjin (CN); Zhixue LI, Tianjin (CN); Huijie YANG, Tianjin (CN); Fei DU, Beijing (CN); Zhan WANG, Beijing (CN)

(21) Appl. No.: 19/296,120

(22) Filed: Aug. 11, 2025

(30) Foreign Application Priority Data
Oct. 11, 2024 (CN) 202411412584.3

(51) Int. Cl. H01F 1/057; B22F 3/12; B22F 3/24; C22C 38/00; C22C 38/10; C22C 38/16; H01F 41/02

(52) U.S. Cl. CPC H01F 1/0577; B22F 3/12; B22F 3/24; C22C 38/002; C22C 38/005; C22C 38/10; C22C 38/16; H01F 41/0266; B22F 2003/248; B22F 2301/355

(57) ABSTRACT

An NdFeB magnet includes R, M, and T. T includes Fe. R includes at least one of Nd, Pr, La, Ce, or Y. M includes at least one of Cr, Co, Ni, Ga, Cu, Ti, Al, Zr, or Nb. The NdFeB magnet includes R₂T₁₄B main phase grains, thin-layer grain boundary phases, and triangular region grain boundary phases. The triangular region grain boundary phases include first intergranular boundary phases and second intergranular boundary phases. R content in the first intergranular boundary phases is less than 30 at %, and R content in the second intergranular boundary phases is greater than 30 at %. On any cross-section of the magnet, a area of the first intergranular boundary phases is in a range of 65% to 86% of a total area of the triangular region grain boundary phases.

### CROSS-REFERENCE TO RELATED APPLICATION

This application claims priority to Chinese Application No. 202411412584.3, filed on Oct. 11, 2024, the entire content of which is incorporated herein by reference.

### TECHNICAL FIELD

The present disclosure relates to magnet, in particular, to an NdFeB magnet and a preparation method thereof.

### BACKGROUND

Sintered NdFeB magnets are widely used in the fields of automotive industry, electronic products, wind power, elevators, industrial robots, aerospace etc., due to their excellent magnetic properties. The demand for these magnets is increasing, and the requirements for magnet performance, residual magnetism, and coercivity are also becoming higher.

To improve the remanence of sintered NdFeB magnets, it is usually needed to reduce the B content in the magnets, but when the B content is low, the R₂T₁₇ phase is formed, which decreases the magnetic properties of the magnets.

In current technologies, in order to meet the high temperature performance requirements of magnets, the coercivity of the magnets is generally increased by directly adding heavy rare earth elements or using heavy rare earth diffusion at grain boundaries, but heavy rare earth elements are expensive, leading to high production costs.

Therefore, how to improve the coercivity of low B content sintered NdFeB magnets and enhance the magnet's temperature coefficient without adding heavy rare earth elements as much as possible is currently a challenging issue that needs to be addressed to meet the current demand for high temperature performance.

### SUMMARY

Given the problems in existing technologies, the present disclosure provides an NdFeB magnet, along with its preparation method and applications. The NdFeB magnet can improve the comprehensive magnetic properties of magnets without adding heavy rare earth elements and reducing the B content, with excellent high-temperature performance and broad application prospects.

To achieve the above object, the present disclosure adopts the following technical solutions:

A first aspect of the disclosure provides an NdFeB magnet, which includes R, M, T and inevitable impurities, wherein the T element includes Fe; the R element includes at least one of Nd, Pr, La, Ce, or Y; and the M element includes at least one of Cr, Co, Ni, Ga, Cu, Ti, Al, Zr, or Nb.

The microstructure of Nd—Fe—B magnets includes: R₂T₁₄B main phase grains, thin-layer grain boundary phases, and triangular region grain boundary phases; the triangular region grain boundary phases consist of the first intergranular boundary phases and the second intergranular boundary phases; the R content is less than 30 at % in the first intergranular boundary phases and the R content is greater than 30 at % in the second intergranular boundary phases; wherein R is a non-heavy rare earth element; on any cross-section of the magnet, the area of the first intergranular boundary phase accounts is in a range of 65% to 86% of the total area of the triangular region grain boundary phases.

The disclosure promotes the growth of more first intergranular boundary phases and second intergranular boundary phases in NdFeB magnets, concentrating more T elements, especially Fe elements, in the triangular region grain boundary phases. This reduces the T element content in the thin-layer grain boundaries, lowers the proportion of ferromagnetic phases in the thin-layer grain boundaries, thereby improving the demagnetization resistance of the magnet, enhancing its temperature stability, and enabling the magnet to maintain a high coercivity at high temperatures.

It is worth noting that when the amount of the first intergranular boundary phases are too small, leading to a lower proportion of the area of the first intergranular boundary phases to the total area of the triangular region grain boundary phases, it is difficult to make the R₂T₁₇ phase disappear, unable to effectively play the pinning effect on the main phase grain, thus making it difficult to consume too much iron in the triangular region grain boundary phases, and ultimately unable to improve the coercivity of the magnet.

Unlike the existing NdFeB magnets, the rare earth elements in the present disclosure do not contain heavy rare earth elements, including any combination of Nd, Pr, La, Ce, or Y, which can significantly reduce the production cost of NdFeB magnets. Typical but non-limiting combinations include Nd and Pr, La and Pr, Nd and La, Nd, Ce, and Y, Nd, Pr, Ce, and La, and so on.

Specifically, the M element includes at least one of Cr, Co, Ni, Ga, Cu, Ti, Al, Zr, or Nb, with typical but non-limiting combinations being Ga and Cu, Co and Cr, Cu, Ga, Al, and Ti, Zr, Al, Cu, and Ga, Cu, Ga, and Zr, Ga, Cu, and Co.

The R content in the first intergranular boundary phase described in the present disclosure is less than 30 at %, for example, it can be 10 at %, 13 at %, 15 at %, 17 at %, 19 at %, 21 at %, 23 at %, 25 at %, 27 at %, or 29 at %, etc., but is not limited to the listed values, other unlisted values within this range are also applicable.

The first intergranular boundary phase in the disclosure is a gray grain boundary phase.

In the second intergranular boundary phase, when R is greater than 30 at %, for example, it can be 31 at %, 32 at %, 33 at %, 34 at %, 35 at %, 36 at %, 38 at %, 40 at %, 41 at %, 44 at %, 48 at %, 50 at %, 55 at %, 57 at %, 60 at %, 62 at %, or 65 at %, etc., but not limited to the listed values. Other unlisted values within this range are also applicable.

On any cross section of the magnet, the area occupied by the first intergranular boundary phase accounts from 65% to 86% of the total area of the triangular region grain boundary phase. For example, it could be 65%, 66%, 67%, 68%, 69%, 70%, 72%, 74%, 75%, 77%, 78%, 80%, 83%, 85%, or 86%, etc., but not limited to the listed values, other values within this range are also applicable.

Optionally, the T content in the first intergranular boundary phase is in a range of 60 at % to 80 at %, for example, it can be 60 at %, 63 at %, 65 at %, 67 at %, 69 at %, 72 at %, 74 at %, 76 at %, 78 at % or 80 at %, etc., but not limited to the listed values, other unlisted values within this range apply as well.

Optionally, the M content in the second intergranular boundary phase is in a range from 5 at % to 20 at %, such as 5 at %, 7 at %, 9 at %, 10 at %, 12 at %, 14 at %, 15 at %, 17 at %, 19 at %, or 20 at %, etc., but not limited to the listed values, other unlisted values within this range apply as well.

Optionally, the content of T in the second intergranular boundary phase is in a range from 20 at % to 60 at %, for example 20 at %, 25 at %, 30 at %, 36 at %, 40 at %, 43 at %, 45 at %, 47 at %, 49 at %, 52 at %, 54 at %, 56 at %, 58 at %, or 60 at %, etc., and not limited to the listed values, other values within this range are also applicable.

Optional, the area of the second intergranular boundary phase on any cross-section of the magnet accounts for 10% to 30% of the total area of the triangular region grain boundary phase, such as 10%, 13%, 15%, 17%, 19%, 22%, 24%, 26%, 28%, or 30%, etc., but not limited to the listed values, other values within this range are also applicable.

Due to the joint effect of the second intergranular boundary phase and the first intergranular boundary phase in consuming iron in the triangular region, the present disclosure further optimizes the area ratio of the second intergranular boundary phase within the above range, which can better promote the disappearance of the R₂T₁₇ phase, thereby effectively consuming excessive iron in the triangular region grain boundary phase, increasing the coercivity of the magnet, and at the same time avoiding the reduction in main phase grain volume fraction when the area ratio of the second intergranular boundary phase is too large, further reducing the residual magnetization of the magnet, as well as reducing the magnet mechanical performance due to the decrease in magnet density efficiency.

The NdFeB magnet also contains B, with the B content in the NdFeB magnet from 0.82 wt % to 0.9 wt %, for example, it can be 0.82 wt %, 0.83 wt %, 0.84 wt %, 0.85 wt %, 0.86 wt %, 0.87 wt %, 0.88 wt %, or 0.9 wt %, etc., but not limited to the listed values, other values within this range that are not listed are also applicable, in some embodiments from 0.835 wt % to 0.87 wt %.

In the present disclosure, the content of B is less than 0.82 wt %, generating the R₂T 17 phase, which cannot improve the coercivity of the magnet; when the content of B is >0.9 wt %, the generation of the first intergranular phase decreases, making it difficult to consume excessive iron in the intergranular phase in the triangle region, difficult to improve the demagnetization resistance of the magnet, and difficult to ensure that the magnet can maintain a high coercivity at high temperatures.

Optionally, the Ga content in the NdFeB magnet is in a range from 0.3 wt % to 0.8 wt %, such as 0.3 wt %, 0.36 wt %, 0.42 wt %, 0.47 wt %, 0.53 wt %, 0.58 wt %, 0.64 wt %, 0.69 wt %, 0.75 wt %, or 0.8 wt %, etc., not limited to the listed values, other unlisted values within this range are also applicable, in some embodiments from 0.45 wt % to 0.7 wt %.

In the present disclosure, when the Ga content is less than 0.3 wt %, the generation of the first intergranular boundary phase and the second intergranular boundary phase is too small, making it difficult for the R₂T₁₇ phase to disappear, thereby making it difficult to consume excessive iron in the grain boundary phase in the ternary zone, and it is difficult to further improve the coercivity of the magnet; when the Ga content is greater than 0.8 wt %, due to the unnecessary Ga presence, the main phase ratio decreases, the residual magnetism decreases, and the overall magnetic performance decreases.

Optionally, the Cu content in the NdFeB magnet is in a range from 0.1 wt % to 0.5 wt %, for example, it can be 0.1 wt %, 0.15 wt %, 0.19 wt %, 0.24 wt %, 0.28 wt %, 0.33 wt %, 0.37 wt %, 0.42 wt %, 0.46 wt %, or 0.5 wt %, etc., but not limited to the listed values, other unlisted values within this range are also applicable, in some embodiments from 0.1 wt % to 0.3 wt %.

In the present disclosure, when the Cu content is less than 0.1 wt %, the generation of the second intergranular boundary phase is too small, making it difficult to consume excessive iron in the grain boundary phase in the ternary zone, and it is difficult to further improve the high coercivity and excellent temperature stability.

Optionally, the R content in the NdFEB magnet is in a range from 31 wt % to 34 wt %, such as 31 wt %, 31.4 wt %, 31.7 wt %, 32 wt %, 32.4 wt %, 32.7 wt %, 33 wt %, 33.4 wt %, 33.7 wt %, or 34 wt %, etc., but not limited to the enumerated values, other values within this range are also applicable.

Optionally, the total content of M in the NdFeB magnet is in a range from 0.01 wt % to 4 wt %, for example 0.01 wt %, 0.46 wt %, 0.9 wt %, 1.34 wt %, 1.79 wt %, 2.23 wt %, 2.67 wt %, 3.12 wt %, 3.56 wt % or 4 wt %, etc., but not limited to the listed values, other unlisted values within this range are also applicable, in some embodiments from 1.1 wt % to 2.7 wt %.

A second aspect of the disclosure provides a method of preparing the NdFeB magnet, comprising: preparing alloy powder according to the composition of NdFeB magnets; performing molding process on the alloy powder to obtain a green compact; and performing sintering process, aging process and post-aging cooling process on the green compact to obtain the NdFeB magnet; wherein, the aging treatment includes the first aging treatment and the second aging treatment, the first aging treatment temperature is in a range of 700° C. to 845° C.; the second aging treatment temperature is in a range of 480° C. to 550° C.

The temperature for the first aging treatment is from 700° C. to 845° C., for example, it can be 700° C., 717° C., 734° C., 750° C., 767° C., 784° C., 800° C., 817° C., 834° C., or 845° C., etc., but not limited to the listed values. Other unlisted values within this range are also applicable. The holding time is from 2 h to 4 h, for example, it can be 2 h, 2.3 h, 2.5 h, 2.7 h, 2.9 h, 3.2 h, 3.4 h, 3.6 h, 3.8 h, or 4 h, etc., but not limited to the listed values. Other unlisted values within this range are also applicable.

The temperature for the second aging treatment is from 480° C. to 550° C., for example, it can be 480° C., 488° C., 496° C., 504° C., 512° C., 519° C., 527° C., 535° C., 543° C., or 550° C., but not limited to the listed values, other unlisted values within this range are also applicable. The holding time is from 1 h to 5 h, for example, it can be 1 hour, 1.5 h, 1.9 h, 2.4 h, 2.8 h, 3.3 h, 3.7 h, 4.2 h, 4.6 h, or 5 h, but not limited to the listed values, other unlisted values within this range are also applicable.

The present disclosure sets the temperatures of the first aging treatment and the second aging treatment within the ranges described above. Given that the intergranular phase components inside the magnet after sintering and cooling are non-uniform and the liquid phase content is relatively high, adopting the temperature range of the first aging treatment described above can promote the flow of the liquid phase and its uniform distribution inside the magnet without affecting the main phase grains, thereby constructing a liquid phase network with uniform components. This network serves as a good foundation for subsequent intergranular reactions to form the first intergranular phase and the second intergranular phase.

If the temperature of the first aging treatment is too low, the non-uniform intergranular phase components inside the magnet after sintering and cooling may induce intergranular reactions, causing the first intergranular phase to overly accumulate in one area. This reduces the distribution uniformity of the first intergranular phase, affecting the consistency of the magnet. Additionally, it decreases the proportion of the first and second intergranular phases formed by subsequent intergranular reactions and reduces the content of element T (such as Fe) consumed in the triangular grain boundary phase.

If the temperature of the first aging treatment is too high, the main phase grains inside the magnet participate in the reaction. Due to the non-uniform distribution of the liquid phase inside the magnet after sintering and cooling and the differences in melting points among internal regions, the proportion of main phase grains participating in the reaction varies, leading to a decrease in the consistency of the magnet. Since the main phase grains participate in the reaction, it cannot be ensured that the first and second intergranular phases are formed in the defined proportions by subsequent intergranular reactions, which affects the consumption of iron in the triangular grain boundary phase. At the same time, the participation of main phase grains in the reaction further increases the iron content of the intergranular phase, affecting the overall demagnetization coupling effect of the magnet.

If the temperature of the second aging treatment is too low, the proportion of the first intergranular phase with high iron content cannot be guaranteed, which affects the consumption of iron content by the triangular grain boundary phase and fails to improve the coercivity of the magnet. If the temperature of the second aging treatment is too high, it promotes the formation of a higher proportion of rare-earth-rich phases, consuming more rare-earth element R. Additionally, it reduces the formation amounts of the first and second intergranular phases, decreases their proportion, and reduces the iron content consumed in the triangular grain boundary phase, which is not conducive to improving the high-temperature stability of the magnet.

In the disclosure, thin-layer grain boundary phase refers to the grain boundary phase formed between two adjacent main phase grains; triangular region grain boundary phase refers to the grain boundary phase surrounded by three or more main phase grains.

Optionally, the preparation of the alloy powder includes: the alloy rapid solidification flake is subjected to hydrogen fragmentation and then air jet milled to obtain the alloy powder.

Optionally, the alloy rapid solidification flake is obtained as a raw material by melting and cooling, the melting temperature is from 1400° C. to 1600° C., for example, it can be 1400° C., 1420° C., 14450° C., 1460° C., 1480° C., 1510° C., 1530° C., 1550° C., 1570° C. or 1600° C., etc., but not limited to the listed values, other unlisted values within this range are also applicable.

Optionally, the particle size D50 of the alloy powder is from 2 μm to 4 μm, for example, it can be 2 μm, 2.3 μm, 2.5 μm, 2.7 μm, 2.9 μm, 3.2 μm, 3.4 μm, 3.6 μm, 3.8 μm, or 4 μm, etc., but not limited to the listed values, other unlisted values within this range are also applicable.

Optionally, the magnetic field strength of the oriented magnetic field is from 1.8 T to 2.3 T, such as 1.8 T, 1.9 T, 2 T, 2.1 T, 2.2 T, or 2.3 T, etc., but not limited to the listed values, other unlisted values within this range are also applicable.

Optionally, the sintering is vacuum sintering.

Optionally, the sintering temperature is from 950° C. to 1050° C., for example, it can be 950° C., 960° C., 970° C., 980° C., 995° C., 1000° C., 1010° C., 1020° C., 1030° C., or 1050° C., etc., but not limited to the listed values. Other unlisted values within this range are also applicable. And/or, the sintering time is from 5 h to 15 h, for example, it can be 5 h, 7 h, 8 h, 9 h, 10 h, 11 h, 12 h, 13 h, 14 h, or 15 h, etc., but not limited to the listed values. Other unlisted values within this range are also applicable.

Optionally, the sintering atmosphere is a vacuum atmosphere. The vacuum degree of the vacuum atmosphere is from 10⁻⁵ Pa to 10⁻² Pa, for example, it can be 10⁻⁵ Pa, 10⁻⁴ Pa, 10⁻³ Pa, or 10⁻² Pa, etc. The vacuum atmosphere pressure is from 5 kPa to 20 kPa, for example, it can be 5 kPa, 7 kPa, 9 kPa, 10 kPa, 12 kPa, 14 kPa, 15 kPa, 17 kPa, 19 kPa, or 20 kPa, etc., but not limited to the listed values, other values within this range are also applicable.

Optionally, the density of the green body obtained after sintering is from 7.5 g/cm³ to 7.8 g/cm³, for example, it can be 7.5 g/cm³, 7.54 g/cm³, 7.57 g/cm³, 7.6 g/cm³, 7.64 g/cm³, 7.67 g/cm³, 7.7 g/cm³, 7.74 g/cm³, 7.77 g/cm³, or 7.8 g/cm³, etc., but not limited to the listed values, other unlisted values within this range are also applicable.

Optionally, the holding time of the first aging treatment is from 2 h to 4 h, for example, it can be 2 h, 2.3 h, 2.5 h, 2.7 h, 2.9 h, 3.2 h, 3.4 h, 3.6 h, 3.8 h, or 4 h, etc., but not limited to the listed values, other unlisted values within this range are also applicable.

Optional, the holding time for the second curing process is from 1 h to 5 h, for example, it can be 1 h, 1.5 h, 1.9 h, 2.4 h, 2.8 h, 3.3 h, 3.7 h, 4.2 h, 4.6 h, or 5 h, etc., but not limited to the listed values, other values within this range not listed are also applicable.

Optionally, the cooling rate of the post-aging cooling exceeds 6.6° C./min, for example, it could be 6.7° C./min, 7.1° C./min, 7.5° C./min, 7.8° C./min, 8.2° C./min, 8.6° C./min, 8.9° C./min, 9.3° C./min, 9.7° C./min, or 10° C./min, etc., but not limited to the listed values, other unspecified values within this range are also applicable.

The preparation method of the present disclosure, utilizing a two-step aging treatment process matched with a rapid cooling rate greater than 6.6° C./min, can promote intergranular reactions within the magnet uniformly, facilitate the effective formation of the first and second grain boundary phases, eliminate the R₂T₁₇ phase, and maintain the consistent structure of the first and second intergranular boundary phases by using the above cooling rate, thus achieving an enhancement in coercivity and high-temperature stability of the magnet.

A third aspect of the disclosure provides the use of an NdFEB magnet produced by the preparation method of the NdFEB magnet as described in the first aspect and/or the NdFeB magnet as described in the second aspect in the automotive industry, electronic products, wind power generation, elevators, industrial robots, or aerospace.

The NdFEB magnets provided by the disclosure, due to their excellent coercivity, remanence, and high temperature stability, can be widely used in various fields with broad application prospects.

Compared with existing technologies, the disclosure has at least the following beneficial effects:

(1) The NdFEB magnet provided by the present disclosure results in a higher proportion of the first intergranular boundary phase and the second intergranular boundary phase in the triangular region grain boundary phase of the magnet, in which the content of T in the two intergranular boundary phases is greater than 80 at %. This leads to a greater concentration of T, especially Fe, elements in the intergranular phases of the magnet, reducing the content of T, especially Fe, elements in the thin layer intergranular phases. As a result, the proportion of ferromagnetic phase in the thin-layer grain boundary phases is reduced, thereby improving the magnet's resistance to demagnetization, enhancing the magnet's temperature stability, allowing the magnet to maintain a higher coercivity at high temperatures. Specifically, the magnet's Br is above 13.16 kGs, HcJ is above 20.06 kOe, and the absolute value of the temperature coefficient α %/° C. of HcJ between 20-180° C. is within 0.565.

(2) The preparation method of the NdFeB magnet provided by the present disclosure further controls the content of B, Ga, and Cu within a specific range, so that the microstructure of the NdFeB magnet includes: R₂T₁₄B main phase grains, the first intergranular boundary phase, and the second intergranular boundary phase, achieving the effective preparation of the corresponding microstructure.

(3) The preparation method of the NdFeB magnet provided by the present disclosure is capable of obtaining NdFeB magnets with high Fe content in the first intergranular boundary phase and the second intergranular boundary phase by adopting aging treatment and controlling the cooling rate after aging treatment within a specific range, thereby significantly improving the high temperature stability of the neodymium iron boron magnet and improving the magnet's resistance to demagnetization.

### BRIEF DESCRIPTION OF THE DRAWING

FIG. 1 is an SEM photograph of the NdFeB magnet prepared in Embodiment 1.

### DETAILED DESCRIPTION OF EMBODIMENTS

The technical solution of the present disclosure is further illustrated with specific implementation methods in conjunction with the accompanying diagrams.

In this disclosure, wt % represents weight percentage and at % represents atomic percentage.

The following further describes the present disclosure, however, the examples herein are merely illustrative of the present disclosure and do not represent or limit the scope of protection of the present invention, the scope of protection of the present disclosure is defined by the claims.

### Embodiment 1

The embodiment provides an NdFeB magnet, the composition of which includes 32.7 wt % of R, 1.5 wt % of M, 0.845 wt % of B, and the balance of T and inevitable impurities;

Where, the R consists of Nd and Pr; the T consists of Fe and Co; the M includes 0.18 wt % Cu and 0.6 wt % Ga.

Preparing the NdFeB magnet by the following steps:
Preparing the alloy rapid solidification flakes: providing raw materials as described in the composition of the NdFeB magnet above, melting the raw materials at 1500° C. followed by cooling;
Preparing the alloy powder: the alloy rapid solidification flakes undergo hydrogen crushing and jet milling to produce the alloy powder. The hydrogen crushing step is carried out at a hydrogen absorption pressure of 0.4 MPa, followed by dehydrogenation at 550° C. The jet milling is conducted at a grinding pressure of 0.68 MPa, the alloy powder with an average particle size (D50) of 3 μm.

Molding the alloy powder: molding the alloy powder to obtain a green compact; the molding treatment is oriented molding under N₂ gas protection with an oriented magnetic induction strength of 2 T.

Sintering: placing the green compact into a vacuum sintering furnace and sintering at 1000° C. for 10 h under a vacuum degree controlled at 10⁻³ Pa to densify the green compact, thereby obtaining a sintered magnet blank having a density of 7.7 g/cm³.

Aging Treatment: subjecting the sintered magnet blank obtained to a first aging treatment at 830° C. for 3 h, followed by a second aging treatment at 520° C. for 1.2 h, and then cooling at a rate of 15° C./min after the aging treatments to obtain the NdFeB magnet.

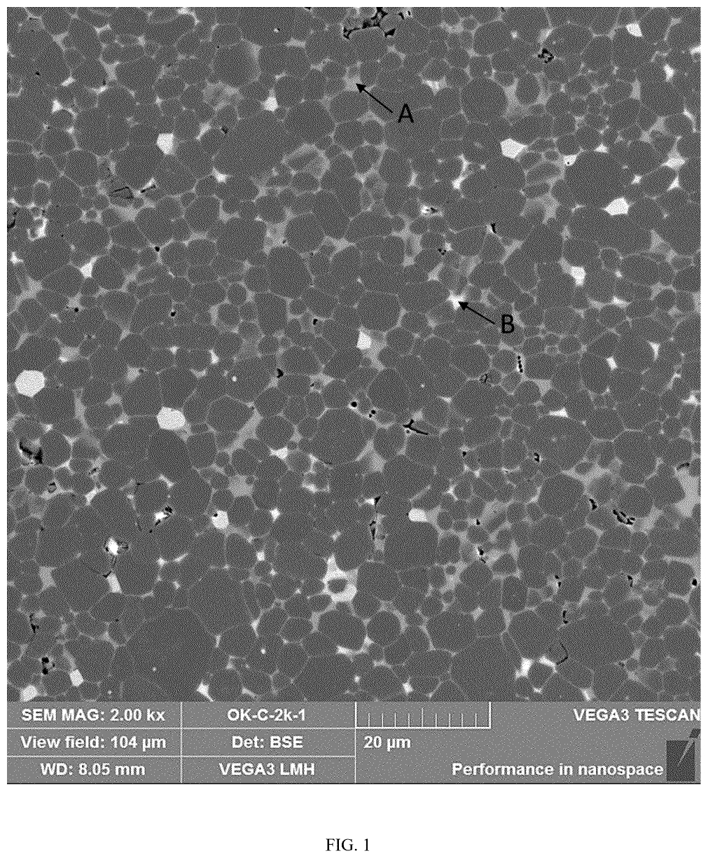

Microscopic structure testing of the prepared NdFeB magnets was carried out. Referring to FIG. 1, the test results showed that the NdFeB magnets consist of main phase grains and intergranular boundary phases. The intergranular boundary phases include thin-layer grain boundary phases and triangular region grain boundary phases. Inside the triangular region grain boundary phases, there are the first intergranular boundary phase (gray intergranular boundary phase in FIG. 1, labeled as A) and the second intergranular boundary phase (white bright intergranular boundary phase in FIG. 1, labeled as B).

The distribution of the first intergranular boundary phase and the second intergranular boundary phase within the grain boundary phase in the triangular region of the NdFEB magnet prepared in Embodiment 1 was statistically calculated using image analysis software (Image ProPlus). The area of the first intergranular boundary phase accounts for 70% of the total area of the triangular region grain boundary phases, and the area of the second intergranular boundary phase accounts for 16% of the total area of the triangular region grain boundary phases.

### Embodiment 2

Referring to the preparation method in Embodiment 1, the difference in Embodiment 2 lies in the composition of the NdFeB magnet, which includes 32.2 wt % R, 1.3 wt % M, 0.845 wt % B, and the balance of T and inevitable impurities; where the R is Nd and Pr; the Tis Fe; and the M comprises 0.15 wt % Cu and 0.58 wt % Ga.

The temperature of the second aging treatment is 500° C.

### Embodiment 3

Referring to the composition of the NdFeB magnet in Embodiment 2, the difference in Embodiment 3 lies in the aging treatment, where the temperature of the first aging treatment is set at 820° C. with a holding time of 4 h, the temperature of the second aging treatment is set at 510° C. with a holding time of 1.3 h, and the cooling at a rate of 7° C./min after the aging treatments.

### Embodiment 4

Referring to the composition of the NdFeB magnet in Embodiment 1, the difference in Embodiment 4 lies in the aging treatment, where the temperature of the first aging treatment is set at 845° C. with a holding time of 2 h, the temperature of the second aging treatment is set at 480° C. with a holding time of 2.5 h.

### Embodiment 5

Referring to the composition of the NdFeB magnet in Embodiment 1, the difference in Embodiment 5 lies in the aging treatment, where the temperature of the first aging treatment is set at 700° C. with a holding time of 3 h, the temperature of the second aging treatment is set at 550° C. with a holding time of 1 h.

### Embodiment 6

Referring to the preparation method in Embodiment 1, the difference in Embodiment 6 lies in the composition of the NdFeB magnet, which includes 0.88 wt % B.

### Comparative Embodiment 1

Referring to the composition of the NdFeB magnet in Embodiment 1, the difference in Comparative Embodiment 1 lies in the first aging treatment, where the temperature of the first aging treatment is set at 860° C.

### Comparative Embodiment 2

Referring to the composition of the NdFeB magnet in Embodiment 1, the difference in Comparative Embodiment 2 lies in the second aging treatment, where the temperature of the second aging treatment is set at 470° C.

### Comparative Embodiment 3

Referring to the composition of the NdFEB magnet in Embodiment 1, the difference in Comparative Embodiment 3 lies in the second aging treatment, where the temperature of the second aging treatment is set at 560° C.

After preparing a sample from the magnet of Embodiment 1, a cross-sectional image was taken using a scanning electron microscope (SEM), and the resulting SEM image is shown in FIG. 1. The observation plane is perpendicular to the orientation direction of the magnet. In the magnet of Embodiment 1, the triangular region grain boundary phases include a first intergranular boundary phase (gray intergranular boundary phase) and a second intergranular white boundary phase (white highlighted intergranular boundary phase). The first intergranular boundary phase and the second intergranular boundary phase can be distinguished based on electron backscatter images, where the contrast of the backscattered electron image of the second intergranular boundary phase is slightly higher than that of the first intergranular boundary phase.

The distribution of the first intergranular boundary phase (grey intergranular boundary phase) and the second intergranular boundary phase (white bright intergranular boundary phase) in the triangular region grain boundary phases can be statistically analyzed using the image pro plus image analysis software: randomly select 5 or more arbitrary cross-sections in the magnet for analysis, randomly select 5 or more 50 μm×50 μm regions for each cross-section, respectively test the area ratio of the first intergranular boundary phases to the triangular grain boundary phase in each region on each cross-section and take the average as the area ratio of the first intergranular boundary phases and the triangular grain boundary phases on that cross-section, then calculate the area ratio of the first intergranular boundary phases and the triangular grain boundary phases for all cross-sections, the results are shown in Table 1; the same statistical method is used for the area ratio of the second intergranular boundary phases and the triangular grain boundary phases for all cross-sections as for the area ratio of the first intergranular boundary phase and the triangular grain boundary phase.

The selected NdFeB magnets prepared according to implementation Embodiments from 1 to 6 and Comparative Embodiments from 1 to 3 were tested by EDS spectroscopy to determine the atomic percentage of each element at the first and second intergranular boundaries, and the results are shown in Table 1.

The magnetic properties of Nd—Fe—B magnets with Embodiments from 1 to 6 and Comparative Embodiments from 1 to 3 were tested using a B—H hysteresis graph, and the results are shown in Table 2.

TABLE 1

| | First intergranular | | | Second intergranular | | | |
|---|---|---|---|---|---|---|---|
| | boundary phase | | | boundary phase | | | |
| | Area percentage | | | Area percentage | | | |
| | of the triangular | | | of the triangular | | | |
| | grain boundary | R | | grain boundary | | | |
| | phase (%) | content | T content | phase (%) | R content | T content | M content |
| Embodiment | 70 | 28.4 | 63.3 | 16 | 47.7 | 35.9 | 16.4 |
| 1 | | | | | | | |
| Embodiment | 82 | 26.6 | 67.4 | 15 | 51.6 | 42.3 | 6.1 |
| 2 | | | | | | | |
| Embodiment | 79 | 25.8 | 66.5 | 16 | 49.8 | 43.6 | 6.6 |
| 3 | | | | | | | |
| Embodiment | 71 | 27.8 | 64.3 | 12 | 49.6 | 40.8 | 9.6 |
| 4 | | | | | | | |
| Embodiment | 75 | 28.1 | 65.1 | 20 | 49.1 | 35.6 | 15.3 |
| 5 | | | | | | | |
| Embodiment | 65 | 28.2 | 59.2 | 13 | 47.3 | 36.2 | 16.5 |
| 6 | | | | | | | |
| Comparative | 64 | 28.6 | 63.5 | 12 | 51.6 | 42.3 | 6.1 |
| Embodiment | | | | | | | |
| 1 | | | | | | | |
| Comparative | 43 | 27.8 | 63.1 | 8 | 52.5 | 38.9 | 8.6 |
| Embodiment | | | | | | | |
| 2 | | | | | | | |
| Comparative | 55 | 28.1 | 62.3 | 5 | 48.6 | 40.3 | 11.1 |
| Embodiment | | | | | | | |
| 3 | | | | | | | |

TABLE 2

| | | | Temperature coefficient |
|---|---|---|---|
| | | | of HcJ from 20° C. to |
| | | | 180° C. absolute |
| | Br (kGs) | HcJ (kOe) | value α %/° C. |
| Embodiment 1 | 13.16 | 21.76 | 0.550 |
| Embodiment 2 | 13.28 | 20.91 | 0.514 |
| Embodiment 3 | 13.22 | 20.88 | 0.513 |
| Embodiment 4 | 13.22 | 20.06 | 0.544 |
| Embodiment 5 | 13.26 | 20.16 | 0.534 |
| Embodiment 6 | 13.36 | 20.1 | 0.565 |
| Comparative | 13.23 | 19.96 | 0.582 |
| Embodiment 1 | | | |
| Comparative | 13.3 | 19.54 | 0.654 |
| Embodiment 2 | | | |
| Comparative | 13.28 | 19.7 | 0.623 |
| Embodiment 3 | | | |

The following observations can be made from Tables 1 to 2:

A comprehensive review of Embodiments from 1 to 6 demonstrates that the NdFeB magnets provided by the present disclosure exhibit a residual magnetic induction (Br) of at least 13.16 kGs and an intrinsic coercivity (HcJ) of at least 20.06 kOe. Additionally, the absolute value of the temperature coefficient α %/° C. of HcJ over the temperature range of 20° C. to 180° C. is within 0.565. These results indicate that the present disclosure has improved the demagnetization resistance of the magnets and enhanced their temperature stability.

A comparison of Embodiment 1 with Comparative Embodiments from 1 to 3 reveals the following: In Comparative Embodiment 1, the first aging treatment was conducted at a temperature of 860° C., which is excessively high. This resulted in a relatively low area percentage of the first grain boundary phase occupying the triangular grain boundary phase, specifically only 64%. In Comparative Examples 2 and 3, the second aging treatment was either too high or too low in temperature, leading to a similarly low area percentage of the first intergranular boundary phase occupying the triangular grain boundary phase, at 43% and 55%, respectively. Consequently, the absolute values of the temperature coefficient α %/° C. of HcJ over the temperature range of 20-180° C. in Comparative Embodiments 1 to 3 were significantly higher, at 0.582, 0.654, and 0.623, respectively. Moreover, the coercivity of the magnets in Comparative Embodiments 1 to 3 was notably lower than that in Embodiment 1. These findings demonstrate that the area percentage of the first intergranular boundary phase occupying the triangular grain boundary phase is crucial for the temperature stability of the magnets. The present disclosure can regulate the area percentage of the first intergranular boundary phase and the triangular grain boundary phase by controlling the aging treatment temperature, thereby enhancing the temperature stability and magnetic properties of the magnets.

The present disclosure provides the detailed structural features through the aforementioned examples. However, the disclosure is not limited to these specific structural features, and it is not intended to imply that the disclosure can only be implemented based on these detailed structural features. It should be understood by those skilled in the art that any improvements to the disclosure, equivalent substitutions of the components used in the disclosure, as well as the addition of auxiliary components and the selection of specific methods, all fall within the scope of the present disclosure.

1. An NdFeB magnet comprising R, M, and T, wherein:
the T includes Fe, the R element includes at least one of Nd, Pr, La, Ce, or Y, and the M element includes at least one of Cr, Co, Ni, Ga, Cu, Ti, Al, Zr, or Nb;
the NdFeB magnet includes R₂T₁₄B main phase grains, thin-layer grain boundary phases, and triangular region grain boundary phases;
the triangular region grain boundary phases include first intergranular boundary phases and second intergranular boundary phases;
an R content in the first intergranular boundary phases is less than 30 at %, and an R content in the second intergranular boundary phases is greater than 30 at %;
a T content in the first intergranular boundary phases is in a range of 60 at % to 80 at %, and a T content in the second intergranular boundary phases is in a range of 20 at % to 60 at %;
an M content in the second intergranular boundary phases is in a range of 5 at % to 20 at %; and
on any cross-section of the magnet, an area of the first intergranular boundary phases is in a range of 65% to 86% of a total area of the triangular region grain boundary phases.

2. The NdFeB magnet according to claim 1, wherein on any cross-section of the magnet, an area of the second intergranular boundary phases is in a range of 10% to 30% of the total area of the triangular region grain boundary phases.

3. The NdFeB magnet according to claim 1, further comprising B, wherein:
a B content in the NdFeB magnet is in a range of 0.82 wt % to 0.9 wt %;
a Ga content in the NdFeB magnet is in a range of 0.3 wt % to 0.8 wt %; and
a Cu content in the NdFeB magnet is in a range of 0.1 wt % to 0.5 wt %.

4. The NdFeB magnet according to claim 3, wherein the Ga content in the NdFeB magnet is in a range of 0.45 wt % to 0.7 wt %, and the B content in the NdFeB magnet is in a range of 0.835 wt % to 0.87 wt %.

5. The NdFeB magnet according to claim 4, wherein the R content in the NdFeB magnet is in a range of 31 wt % to 34 wt %, and the M content in the NdFeB magnet is in a range of 0.01 wt % to 4 wt %.

6. A method for preparing the NdFeB magnet according to claim 1, comprising:
preparing alloy powder according to a composition of the NdFeB magnets;
performing molding process on the alloy powder to obtain a green compact; and
performing sintering process, aging process, and post-aging cooling process on the green compact to obtain the NdFeB magnet;
wherein the aging process includes a first aging treatment performed at a temperature in a range of 700° C. to 845° C. and a second aging treatment performed at a temperature in a range of 480° C. to 550° C.

7. The method according to claim 6, wherein:
preparing the alloy powder includes subjecting alloy flakes to hydrogen decrepitation and jet milling to obtain the alloy powder;
a particle size D50 of the alloy powder is in a range of 2 μm to 4 μm; and
a magnetic field strength of an oriented magnetic field during the molding process is in a range from 1.8 T to 2.3 T.

8. The method according to claim 6, wherein the sintering process is performed in vacuum with a vacuum degree in a range from 10⁻⁵ Pa to 10⁻² Pa.

9. The method according to claim 6, wherein:
a cooling rate in the post-aging cooling process is greater than 6.6° C./min; and
a holding time of the first aging treatment is from 2 h to 4 h, and a holding time of the second aging treatment is from 1 h to 5 h.
